(19) United States
(12) Patent Application Publication
(10) Pub. No.: US 2009/0230907 A1
(43) Pub. Date: Sep. 17, 2009

(54) Method and Circuit Arrangement for Continously Supplying Power to a Brushless Electric Motor

(76) Inventor: Johannes Scharzkopf, Marktheidenfeld (DE)

Correspondence Address: MANELLI DENISON & SELTER, 2000 M STREET NW SUITE 700, WASHINGTON, DC, 20036-3307, US

(21) Appl. No.: 12/309,266

(22) PCT Filed: Jul. 4, 2007
(86) PCT No.: PCT/EP2007/056711

§ 371 Date: Feb. 25, 2009

(30) Foreign Application Priority Data
Jul. 14, 2006 (DE) 10 2006 032 705.5

(51) Int. Cl. H02P 6/14

(52) U.S. Cl. 318/400.27

(57) ABSTRACT

The invention relates to a method for controlling a brushless electric motor comprising a plurality of winding branches (21, 22, 23) and a circuit arrangement (1) suitable therefor. The temporal progression of the clamping potential (Uu, Uv, Uw) is produced respectively by clocked switches between a low and a high electric potential. At least one of the clamping potentials (Uu, Uv, Uw) is constantly produced in time segments in a variation free manner by switches on one of the electric potentials, and the additional clamping potentials (Uu, Uv, Uw) are produced by modifying the clocking. According to the invention, in the temporal progression, the clamping potentials (Uu, Uv, Uw) are constantly produced in an alternating manner in accordance with the variable of the respectively associated clamping flow. As a result, switching losses are reduced.

The invention relates to a method for continuously supplying power to a brushless electric motor comprising a plurality of winding phases, wherein the temporal profile of the terminal potentials is generated in each case by clocked switching between a low and a high electrical potential, wherein at least one of the terminal potentials is generated in constant fashion in time segments in a variation-free manner by switching to one of the electrical potentials, and wherein the further terminal potentials are generated in adapted fashion by changing the clocking. The invention furthermore relates to a circuit arrangement designed for supplying power in this way to a brushless electric motor comprising a plurality of winding phases.

As is known, brushless electric motors are driven by alternately connecting the winding phases in such a way that a rotating magnetic field results which brings about a torque between the stator and the rotor of the electric motor. For this purpose, an electric motor of this type contains at least two, often three, winding phases arranged offset by an angle with respect to one another relative to the rotor axis. The coils and thus the rotating magnetic field are often assigned to the stator of the electric motor, while the rotor comprises a permanent magnet.

For generating the rotating magnetic field, a specific temporal profile of the terminal potentials present at the terminals of the winding phases is necessary. For this purpose, converters are used which switch intelligently between a low and a high electrical potential of a DC voltage circuit or intermediate circuit, whereby the desired terminal potentials and the currents necessary for driving the electric motor are generated in the winding phases. In this case, each feed line to a terminal or to a winding phase of the electric motor is assigned a pair of switches, in particular transistors, e.g. MOSFETs, or high-power semiconductors, e.g. IGBTs, which permit a changeover between the two potentials of the DC voltage circuit. In this way, the temporal profile of the terminal potentials is generated in each case by clocked switching between a low and a high electrical potential.

A method of the type mentioned in the introduction for continuously supplying power to a brushless electric motor comprising a plurality of winding phases is known from the dissertation “Mikrorechner für die vollständig digitale Regelung von Permanentmangnet-Synchronservomotoren” [“Microcomputers for the fully digital control of permanent-magnet synchronous servomotors], Hans-Christian Reuss, Technical University of Berlin, 1989, wherein, on the basis of continuous sinusoidal energization, for a brushless electric motor comprising three winding phases in star connection, a method is described in which, with variation of the star point potential, the terminal potential with the respectively lowest value is in each case assigned to the zero potential.

The required switching changes between the high and the low potential of the DC voltage circuit are thereby reduced since the switching processes are obviated in the winding phase having the lowest terminal potential in each case. In this way, by comparison with a conventional control with a symmetrical profile of the terminal potentials, it is possible to generate higher phase voltages, that is to say voltages dropped across a winding phase, from the potential difference of the DC voltage circuit.

It is an object of the invention to further develop a method for continuously supplying power to a brushless electric motor of the type mentioned in the introduction in such a way that the switching losses can be reduced. It is furthermore an object of the invention to specify a circuit arrangement suitable for carrying out a method of this type.

The first-mentioned object is achieved according to the invention, for a method of the type mentioned in the introduction, by virtue of the fact that, in the temporal profile, the terminal potentials are generated in constant fashion alternately depending on the magnitude of the respectively assigned terminal current.

In this case, in a first step, the invention is based on the insight that switching losses occur in the converter during the control of the brushless electric motor. If a MOSFET for example is switched off, then it undergoes a transition to a high-impedance state continuously rather than abruptly. Driven by inductances, the current flows further with an approximately constant magnitude. Power loss arises. Power loss likewise arises if the voltage dropped rises to an extent such that a current flows via a freewheeling diode. Overall, an energy loss proportional to the current arises in the converter per switching process. In this case, the proportionality factor is essentially dependent on the switching speed and the intermediate circuit voltage. The switching losses result in a reduction of the efficiency and an increased inherent heating. This is disadvantageous particularly when the brushless electric motor is used in a hot environment, such as, for example, in the engine compartment of a motor vehicle. Moreover, the switching causes transience with high frequency components which adversely affect the electromagnetic compatibility.

In a second step, the invention is based on the consideration that the potential is not relevant to the power of the electric motor. The electric motor will achieve the same power or rotational speed independently of the absolute potential set, as long as the phase voltages or the potential differences between the terminals are maintained. If the phase voltages remain unchanged, then the same motor currents flow, such that the torque and the efficiency of the electric motor remain the same unchanged. The terminal potentials can therefore be altered without influencing the motor characteristic variables as long as the phase voltages or the potential differences between the terminals are maintained.

The targeted selection of the terminal potential to be generated in constant fashion in a manner dependent on the assigned terminal current, that is to say that current which flows through the corresponding motor terminal, thus permits a further reduction of the switching losses without influencing the characteristic variables of the electric motor. That terminal potential to which the largest terminal current in each case is assigned is in each case generated in constant fashion. Since the energy loss caused by switching processes is proportional to the current, a minimization of the energy loss is thereby obtained overall. In this case, the terminal current can either be measured, be derived from other electrical variables, such as the phase voltage, for example, or be assumed theoretically.

Alongside the possibility for reducing the power loss, the invention furthermore affords the advantage that the AC current component in the DC voltage circuit decreases. An intermediate circuit capacitor used for smoothing can therefore be given smaller dimensioning, which is cost-effective. Since the current ripple in the DC voltage circuit is reduced, power interference sources present also no longer have such a great effect.

The adaptation of the further terminal potentials can be performed in accordance with predetermined phase voltage profiles or predetermined terminal or phase current profiles.

In a further advantageous configuration, the assigned control potential is in each case determined on the basis of a variation of the clocking of all the terminal potentials, and the terminal potential generated in constant fashion is in each case switched to the potential closest to the corresponding control potential. In this case, the control potential is understood to mean that potential which would have to be set given predetermined clocking of the change between high and low potential of all the terminal potentials in accordance with a predetermined current profile. This configuration affords the advantage that the remaining terminal potentials can be generated with optimum utilization of the intermediate circuit voltage by altered clocking for obtaining the phase voltages.

Expediently, the terminal potential with the highest or lowest value of the corresponding control potential is in each case generated in constant fashion. This configuration is based on the insight that, to a first approximation, the highest motor current flows through that motor winding at which the terminal potential having the highest magnitude is present. The switching losses are therefore minimized when, on the basis of a variation of the clocking of all the terminal potentials with an identical temporal profile of the phase voltages, the terminal potential which would have the highest or lowest corresponding control potential in time segments is generated in constant fashion. A reduction of the switching losses by comparison with the prior art is thereby obtained without direct measurement of the terminal current.

Advantageously, the terminal potential to which the highest actual terminal current is assigned is generated in constant fashion on the basis of the assigned highest or lowest control potential. In this case, the decision as to which terminal potential is generated in constant fashion depends on the actual terminal current. In this respect, the power loss can be reduced further.

Advantageously, the temporal profile of the terminal potentials is generated in each case by means of pulse width modulation. Pulse width modulation (abbreviated to PWM) involves varying the switch-on and switch-off time of a rectangular signal with a fixed fundamental frequency. In this case, for an inductive load, the voltage present on average can be varied over the duration of the switch-on time. If the rectangular signal is switched on for example for only half of the total available time, then the load sees on average only half of the voltage present during the switch-on time. For generating the temporal profile of the terminal potentials, during a PWM clock cycle, the different switching states of a corresponding changeover means for switching between the low and the high electrical potential of the DC voltage circuit are maintained for different periods of time.

For driving the electric motor, it is possible to have recourse to a PWM converter, by way of example. In the case of driving a customary electric motor having three winding phases, the converter required has, in the case of a customary control, for each of the three feed lines, in each case two switches of transistors which alternately switch the feed line back and forth between the two potentials of a DC voltage circuit. Since, in the temporal profile of the terminal potentials, in each case at least one of the terminal potentials is kept constant for a time segment, it is possible to have recourse to a microcontroller having fewer PWM outputs for the driving of the PWM converter. Thus, a microcontroller having at least three PWM outputs is necessary for example for an electric motor having three winding phases in the case of conventional driving. If the electric motor is driven in the manner described above, then only a microcontroller having two PWM outputs is required. The costs for the required components are thereby reduced overall.

The invention is not restricted to specific time profiles of the terminal potentials. In particular, the temporal profiles of the terminal potentials can also be trapezoidal or triangular. Advantageously, however, the terminal potentials are in each case generated in sinusoidal fashion over time. This permits an optimization of the efficiency of a brushless electric motor. In the case of an electric motor having three winding phases, the sinusoidal terminal potentials are phase-shifted respectively by 120° in this case. The rotating magnetic field required is thereby generated.

The second-mentioned object is achieved, by means of a circuit arrangement comprising a DC voltage intermediate circuit and a supply circuit that is connected into the DC voltage intermediate circuit between a feed line and a return line, can in each case be connected to the terminals of the winding phases of the electric motor and contains changeover means, wherein the changeover means are provided for the clocked switching of the terminals between the feed line and return line, according to the invention by virtue of the embodying of a control unit for driving the changeover means in accordance with the abovementioned method.

Advantageously, in this case the supply circuit is designed for the pulse width modulation of the terminal potentials.

Exemplary embodiments of the invention will be explained in more detail with reference to a drawing, in which:

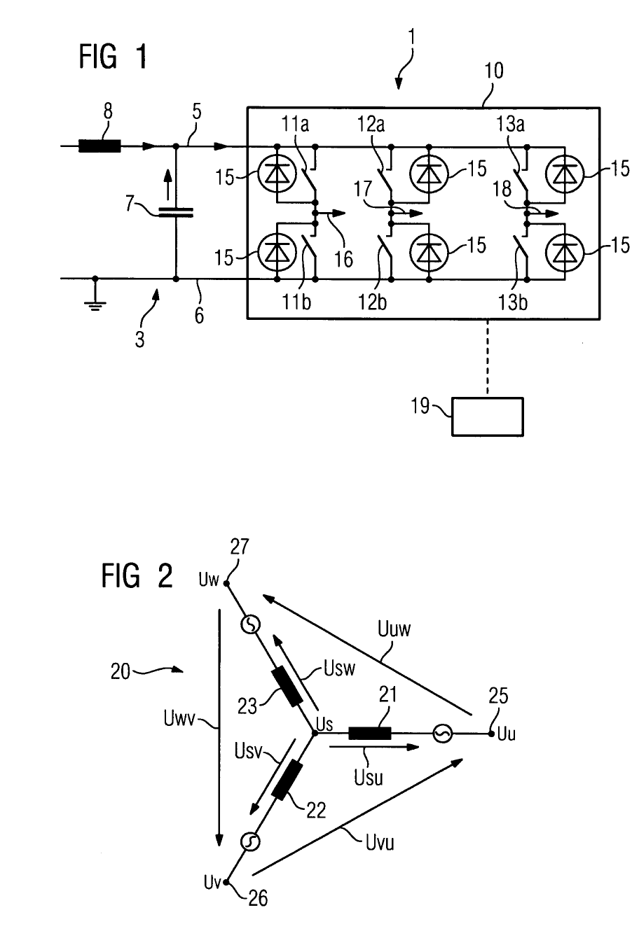

FIG. 1 schematically shows a circuit arrangement for driving a brushless electric motor,

FIG. 2 schematically shows a star connection of three winding phases of an electric motor,

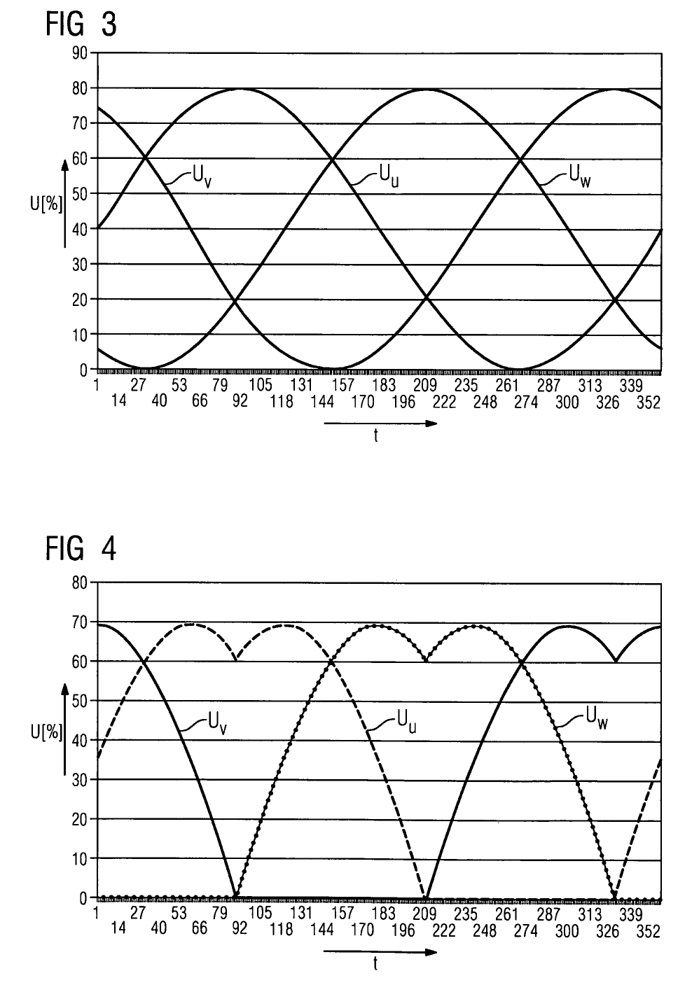

FIG. 3 shows a sinusoidal profile of the terminal potentials of an electric motor with three winding phases,

FIG. 4 shows a profile of the terminal potentials for an electric motor with three winding phases, wherein a respective one of the terminal potentials is pulled to low potential, and

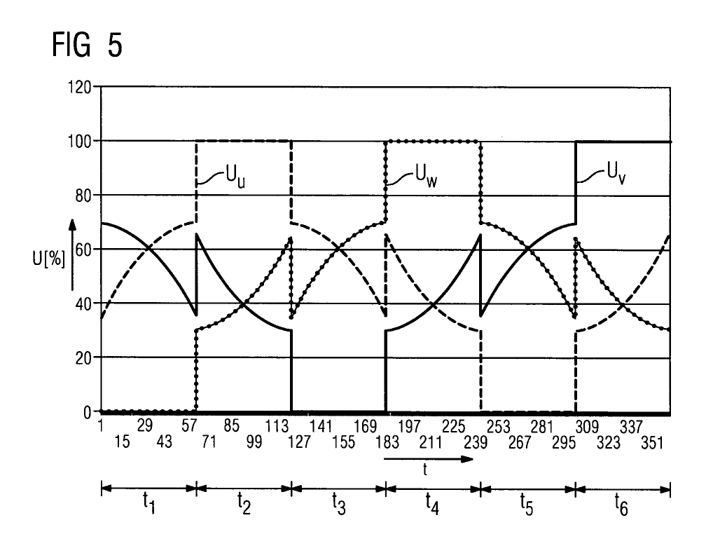

FIG. 5 shows a profile of the terminal potentials for an electric motor with three winding phases, wherein the terminal potentials are in each case alternately put to the low or high potential of a DC voltage intermediate circuit in constant fashion for a predetermined time segment.

FIG. 1 schematically illustrates a circuit arrangement 1 for driving a brushless electric motor comprising three winding phases. The circuit arrangement 1 comprises a DC voltage intermediate circuit 3 supplied by a capacitor, for example, with a feed line 5 and with a return line 6. In this case, the feed line 5 is at a high potential (HIGH) and the return line 6 is at low potential (LOW), namely ground. In order to keep the current ripple in the feed line 5 as small as possible and the voltage of the DC voltage intermediate circuit 3 as constant as possible, a capacitor 7 and an inductance 8 are connected in the DC voltage intermediate circuit 3. A converter 10 for clocked switching between the low and the high electrical potential is connected between the feed line 5 and the return line 6 of the DC voltage intermediate circuit 3.

For generating the terminal potentials for the winding phases of the electric motor, the converter 10 has respective pairs of switches 11a, 11b and 12a, 12b and 13a, 13b embodied as transistors, in particular as MOSFETS. Each individual one of these switches 11a, 11b, 12a, 12b, 13a, 13b is bridged by freewheeling diodes 15 directed counter to the current direction. A first feed line 16, a second feed line 17 and a third feed line 18 respectively are connected between the switch pairs 11a, 11b and 12a, 12b and 13a, 13b. Said feed lines 16, 17, 18 are connected to the terminals of the electric motor during operation. In this case, the winding phases of the electric motor are star-connected, in particular.

For the clocked switching of the terminals between feed line 5 and return line 6 and thus between the high and the low potential of the DC voltage intermediate circuit 3, the switches 11a, 11b and 12a, 12b and 13a, 13b are alternately opened and switched. If the switches 11a, 12a and 13a are closed, then the corresponding motor terminals are at the high potential of the feed line 5 via the feed lines 16, 17 and 18, respectively. The switches 11b, 12b and 13b are open in this case. If, conversely, the switches 11b, 12b and 13b are closed and the switches 11a, 12a and 13a are open, then the motor terminals are at the low potential of the return line 6 via the corresponding feed lines 16, 17 and 18, respectively. With the in total six switches 11a, 11b, 12a, 12b, 13a and 13b, a total of eight circuit states can be achieved in which each of the terminals of the electric motor is either at the high potential or at the low potential. In the case of six of these circuit states, a respective one of the terminals of the motor is at a different potential relative to the other two terminals.

By means of a clocked variation of the circuit states, it is possible to generate the desired temporal profile of the terminal potentials for the driving of the electric motor, such that the rotor of the electric motor rotates. For the driving of the converter 10, use is made of a control unit 19 fashioned as a microcontroller having PWM outputs which output, as PWM signal, a signal representing the respectively desired duty ratio between switch-on and switch-off time. This PWM signal is applied, within a predetermined PWM clock cycle, in each case to the switches 11a, 11b, 12a, 12b, 13a and 13b, for the generation of the desired temporal profile of the terminal potentials. With skillful utilization of the PWM outputs of the microcontroller, at least a microcontroller having n PWM outputs is required for driving an electric motor comprising n winding phases. In the case of driving in accordance with the method described above, one PWM output for the microcontroller can be omitted. Thus, for an electric motor comprising three winding phases, for example, only a microcontroller having two PWM outputs is required. This is due to the fact that during a revolution of the rotor of the electric motor, one of the terminal potentials is always kept constant for a certain time segment. No PWM driving is necessary during this time segment.

FIG. 2 schematically illustrates a star connection 20 for an electric motor comprising three winding phases 21, 22 and 23. By virtue of the star connection, the electric motor consequently has a first, second and third terminal 25, 26 and 27, respectively, at which a respective terminal potential is present for driving.

The motor windings 21, 22 and 23 of a so-called three-phase electric motor are generally also designated by the letters U, V and W. The terminal potentials Uu, Uv and Uw are accordingly present at the terminals 25, 26 and 27, respectively. The so-called star voltage Us arises at the star point. A respective phase voltage Usu, Usv and Usw is dropped across the individual winding phases 21, 22 and 23 as the difference between the potentials of the star point and of the respective terminals 25, 26 and 27. Between the terminals 25, 26 and 27, a respective difference voltage Uvu, Uwv and Uuw arises as the difference between the terminal potentials. The difference voltages Uvu, Uwv and Uuw also represent a measure of the respective phase voltages Usu, Usv and Usw. In other words, the phase voltages Usu, Usv and Usw can also be deduced by difference formation from the terminal potentials Uu, Uv and Uw, respectively.

FIG. 3 illustrates the temporal profile of the terminal potentials Uv, Uu and Uw for the terminals of a three-phase brushless electric motor. In this case, the time t is plotted on the abscissa and the value of the potential U in percent of the high potential of the DC voltage intermediate circuit 3 in accordance with FIG. 1 is plotted on the ordinate.

The three terminal potentials Uv, Uu and Uw each have a sinusoidal temporal profile, and are phase-offset respectively by 120° in relation to one another. As a result of such driving, a continuous sinusoidal current in each case arises in the motor windings.

In the case of regular driving of a three-phase electric motor, the amplitudes of the terminal potentials Uv, Uu and Uw vary around a value of 50% of the high potential. In other words, in the case of conventional driving in an electric motor with a star connection in accordance with FIG. 2 at the star point an average potential of 50% of the high potential or a corresponding voltage with respect to ground will be established. In this case, the star point potential remains constant over time.

In the case illustrated, the star point potential has fallen to 40%. This takes place as a result of correspondingly changed clocking of the switches 11a, 11b, 12a, 12b, 13a and 13b of the converter 10 in accordance with FIG. 1. The motor characteristic variables are not altered thereby since the phase voltages, which can in particular also be determined from a difference between the terminal potentials Uv, Uu and Uw, remain unchanged.

FIG. 4 illustrates the temporal profile of the terminal potentials Uv, Uu and Uw, wherein, in comparison with the profile in accordance with FIG. 3, the respectively lowest terminal potential among the terminal potentials Uv, Uu and Uw is put at the potential zero or at ground. In this case, the corresponding switch 11b, 12b or 13b of the converter 10 in accordance with FIG. 1 remains closed in constant fashion. In order that the winding currents or the winding voltages do not change, the respective other terminal potentials are correspondingly adapted by means of changed clocking. This results in the temporal profile that can be seen from FIG. 4. Overall, the switching processes for the driving of the electric motor are thereby reduced. The differences between the individual terminal potentials Uv, Uu and Uw remain unchanged relative to the temporal profile illustrated in FIG. 3. Consequently, the motor characteristic variables are not altered by driving of the electric motor in accordance with FIG. 4. However, the star point potential no longer remains temporally constant.

FIG. 5 then again illustrates the temporal profile of the terminal potentials Uu, Uw and Uv, wherein in order to minimize the switching losses in the temporal profile in each case that terminal potential is switched to the low or the high electrical potential of the DC voltage intermediate circuit in accordance with FIG. 1 which, in the case of a variation of the clocking of all the terminal potentials Uu, Uv and Uw with the same temporal profile of the phase voltages, has the respectively highest or lowest control potential, which can be gathered from the terminal potentials Uu, Uv, Uw in accordance with FIG. 3.

In the realistic case, either the highest or the lowest terminal potential is present at that winding phase having the winding current having the highest magnitude. Theoretically, a reduction of the switching losses by 50% in comparison with conventional driving results in the case of driving of the electric motor in accordance with FIG. 5. A reduction of the switching losses by at least 25% in comparison with conventional driving results in the worst case of a current distribution.

If FIG. 5 is compared with FIG. 3, this reveals the temporal profile of the terminal potentials Uu, Uv and Uw that is illustrated in FIG. 5. In the time segment t₁, the control potential Uw in accordance with FIG. 3 has the lowest value. The closed potential is the low potential ground. Consequently, the terminal potential Uw here is pulled to the low potential ground. In the time segment t₂, the control potential Uu in accordance with FIG. 3 has the highest value. The closest potential is the high potential. Consequently, the terminal potential Uu is switched to the high potential for the time segment t₂. Correspondingly, in the time segment t₃ the terminal potential Uv is pulled or switched to the low potential, in the time segment t₄ the terminal potential Uw is pulled or switched to the high potential, in the time segment t₅ the terminal potential Uu is pulled or switched to the low potential, and in the time segment t₆ the terminal potential Uv is pulled or switched to the high potential. The respective other terminal potentials are adapted by changed clocking, such that the temporal profile of the phase voltages or of the differences between the terminal potentials Uv, Uu and Uw remains unchanged.

In the case of driving of a brushless electric motor comprising three winding phases with the temporal profile of the terminal potentials Uu, Uv and Uw that is illustrated in FIG. 5, the current ripple in the DC voltage intermediate circuit is furthermore reduced. Consequently, the intermediate circuit capacitor can be given smaller dimensioning.

1-7. (canceled)

8. A method for continuously supplying power to a brushless electric motor comprising a plurality of winding phases (21, 22, 23), wherein the temporal profile of the terminal potentials (Uu, Uv, Uw) is generated in each case by clocked switching between a low and a high electrical potential, wherein at least one of the terminal potentials (Uu, Uv, Uw) is generated in constant fashion in time segments in a variation-free manner by switching to one of the electrical potentials, and wherein the further terminal potentials (Uu, Uv, Uw) are generated in adapted fashion by changing the clocking, the method comprising:
in the temporal profile, generating the terminal potentials (Uu, Uv, Uw) in constant fashion alternately depending on the magnitude of the respectively assigned terminal current, wherein in that that terminal potential (Uu, Uv, Uw) to which the largest terminal current in each case is assigned is in each case generated in constant fashion.

9. The method as claimed in claim 8,
wherein the control potential is in each case determined on the basis of a variation of the clocking of all the terminal potentials (Uu, Uv, Uw), and in that the terminal potential (Uu, Uv, Uw) generated in constant fashion is in each case switched to the potential closest to the corresponding control potential.

10. The method as claimed in claim 9,
wherein the terminal potential (Uu, Uv, Uw) with the highest or lowest value of the corresponding control potential is in each case generated in constant fashion.

11. The method as claimed in claim 10,
wherein the terminal potential (Uu, Uv, Uw) to which the highest terminal current is assigned is generated in constant fashion on the basis of the assigned highest or lowest control potential.

12. The method as claimed in any of the preceding claims,
wherein the temporal profile of the terminal potentials (Uu, Uv, Uw) is generated in each case by means of pulse width modulation.

13. A circuit arrangement (1) for controlling a brushless electric motor comprising a plurality of winding phases (21, 22, 23), comprising a DC voltage intermediate circuit (3) and comprising a supply circuit that is connected into the DC voltage intermediate circuit (3) between a feed line (5) and a return line (6), can in each case be connected to the terminals (25, 26, 27) of the winding phases (21, 22, 23) of the electric motor and contains changeover means, wherein the changeover means are provided for the clocked switching of the terminals (25, 26, 37) between the feed line (5) and return line (6),
characterized by a control unit (19) for driving the changeover means in accordance with the method according to any of the preceding claims.

14. The circuit arrangement (1) as claimed in claim 13,
wherein the supply circuit is designed for the pulse width modulation of the terminal potentials.
